(19) United States
(12) Patent Application Publication
(10) Pub. No.: US 2019/0036132 A1
(43) Pub. Date: Jan. 31, 2019

(54) FUEL CELL SYSTEM

(71) Applicant: TOYOTA JIDOSHA KABUSHIKI KAISHA, Toyota-shi (JP)

(72) Inventors: Yusuke MIYAMOTO, Toyota-shi (JP); Tomotaka ISHIKAWA, Nagoya-shi (JP); Atsuo IIO, Nagoya-shi (JP)

(73) Assignee: TOYOTA JIDOSHA KABUSHIKI KAISHA, Toyota-shi (JP)

(21) Appl. No.: 16/045,221

(22) Filed: Jul. 25, 2018

(30) Foreign Application Priority Data
Jul. 28, 2017 (JP) 2017-146205
Jul. 25, 2018 (JP) 2018-138994

(51) Int. Cl. H01M 8/04089; H01M 8/04537; H01M 8/0438; H01M 8/0432; H01M 8/04746; H01M 8/04701

(52) U.S. Cl. CPC H01M 8/04089; H01M 8/04559; H01M 8/04708; H01M 8/0432; H01M 8/04753; H01M 8/0438

(57) ABSTRACT

In a fuel cell system, after a controller performs stop process of stopping power generation by a fuel cell, the controller performs hydrogen supply process n times (n is a natural number of one or more) if a residual hydrogen estimated amount showing an estimated amount of hydrogen remaining in an anode side of the fuel cell is smaller than a threshold. The hydrogen supply process is to supply hydrogen of a first supply amount responsive to a difference between the threshold and the residual hydrogen estimated amount. If a cathode potential acquired in the hydrogen supply process performed for an n-th time satisfies a correction condition, the controller corrects the residual hydrogen estimated amount by reducing the residual hydrogen estimated amount before supply of hydrogen in the n-th hydrogen supply process.

### CROSS REFERENCE TO RELATED APPLICATIONS

The present application claims the priority based on Japanese Patent Application No. 2017-146205 filed on Jul. 28, 2017 and Japanese Patent Application No. 2018-138994 filed on Jul. 25, 2018, the disclosures of which are hereby incorporated by reference in their entirety.

### BACKGROUND

### Field

A technique disclosed in this specification relates to a fuel cell.

### Related Art

Japanese Patent Application Publication No. 2016-139590 discloses a technique of performing degradation suppressing process applied to a vehicle with a fuel cell. This process includes process of consuming oxygen remaining in the fuel cell by generating power while ignition is off. Ignition originally means the ignition of an internal combustion engine and is not an appropriate term in the field of fuel cell systems. However, an ignition switch has been used for many years as a term meaning a starting switch of a vehicle by those in the art. For this reason, in Japanese Patent Application Publication No. 2016-139590, ignition itself is considered to be used as a term meaning an operation element as a starting switch of a vehicle (specifically, a switch for starting power generation in a fuel cell).

In a fuel cell, the occurrence of an abnormal potential may degrade an electrode. A technique provided in this specification is to supply hydrogen of an amount appropriate for reducing the occurrence of an abnormal potential while a fuel cell stops power generation.

A technique disclosed in this specification has been developed to address the foregoing problem and is feasible in the following aspects.

### SUMMARY

According to one aspect of the technique disclosed in this specification, a fuel cell system is provided. The fuel cell system comprises: a fuel cell; an anode gas supply unit that supplies hydrogen as anode gas to the fuel cell; a cathode gas supply unit that supplies cathode gas to the fuel cell; a controller that controls operation of the fuel cell; and a potential measuring part that measures a cathode potential at the fuel cell. In this fuel cell system, after the controller performs stop process of stopping power generation by the fuel cell, the controller performs hydrogen supply process n times (n is a natural number of one or more) if a residual hydrogen estimated amount showing an estimated amount of the hydrogen remaining in an anode side of the fuel cell is smaller than a threshold. The hydrogen supply process is to make the anode gas supply unit supply the hydrogen of a first supply amount responsive to a difference between the threshold and the residual hydrogen estimated amount. If the cathode potential acquired in the hydrogen supply process performed for an n-th time satisfies a correction condition, the controller corrects the residual hydrogen estimated amount by reducing the residual hydrogen estimated amount before supply of the hydrogen in the n-th hydrogen supply process. If n is one, the correction condition is satisfied if the cathode potential acquired in the n-th hydrogen supply process is higher than the cathode potential acquired in the stop process. If n is two or more, the correction condition is satisfied if the cathode potential acquired in the n-th hydrogen supply process is higher than the cathode potential acquired in the hydrogen supply process performed for an (n−1)-th time.

The technique disclosed in this specification is feasible in various aspects. For example, this technique is feasible as a movable body with a fuel cell system, a method of controlling the fuel cell system, etc.

### BRIEF DESCRIPTION OF THE DRAWINGS

FIG. 1 is an explanatory view schematically showing a fuel cell system according to a first embodiment of the present disclosure;

FIG. 2 is a flowchart showing a flow of hydrogen supply process;

FIG. 3 is an explanatory view conceptually showing change in a cathode potential with time; and

FIG. 4 is an explanatory view conceptually showing change in anode-side hydrogen partial pressure and change in a cathode potential with time.

### DETAILED DESCRIPTION

### A. First Embodiment

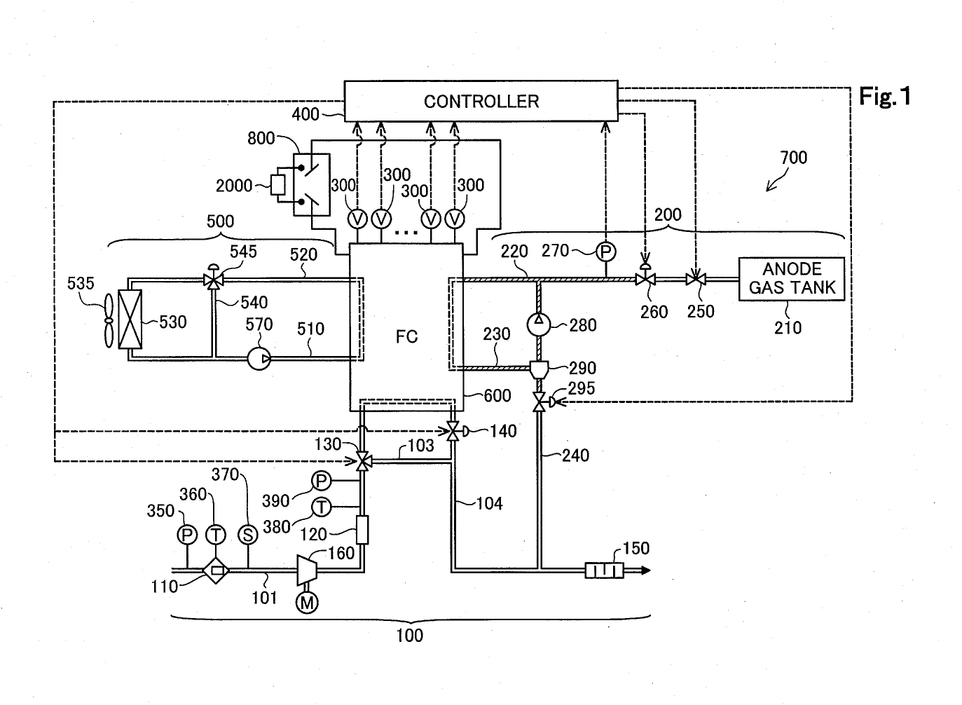

FIG. 1 is an explanatory view schematically showing a fuel cell system 700 according to a first embodiment of the present disclosure. The fuel cell system 700 includes a fuel cell 600, an FC cooling unit 500, an anode gas supply unit 200, a cathode gas supply unit 100, a load connection 800, and a controller 400. The fuel cell system 700 may be installed on a vehicle as a power source for the vehicle or a fixed fuel cell system.

The fuel cell 600 has a stack structure with multiple stacked unit cells as power generators (not shown in the drawings). In this embodiment, the fuel cell 600 is a solid polymer fuel cell. Alternatively, a fuel cell of a different type may be used. A carbon material is used as a carrier for an electrode catalyst in the fuel cell 600. An output voltage from the fuel cell 600 is changed based on the performance of each unit cell, the number of stacked unit cells, and conditions for operating the fuel cell 600 (temperature, humidity, etc.). In this embodiment, an output voltage from the fuel cell 600 determined when the fuel cell 600 generates power at an operating point of producing highest power generation efficiency is about 280 V.

The fuel cell 600 includes a potential measuring part 300 provided at each unit cell for measuring a cathode potential at each unit cell. The cathode potential measured by each potential measuring part 300 is output to the controller 400.

The FC cooling unit 500 includes a cooling medium supply pipe 510, a cooling medium discharge pipe 520, a radiator 530, a bypass pipe 540, a three-way valve 545, and a cooling medium pump 570. For example, water, antifreeze water such as ethylene glycol, or air is used as the cooling medium. The cooling medium pump 570 is placed at the cooling medium supply pipe 510 and used for supplying the cooling medium to the fuel cell 600. The three-way valve 545 is a valve for adjusting the flow rate of the cooling medium to flow into the radiator 530 and the bypass pipe 540. The radiator 530 is provided with a radiator fan 535.

The anode gas supply unit 200 includes an anode gas tank 210, an anode gas supply pipe 220, an anode gas reflux pipe 230, a main stop valve 250, a pressure-adjusting valve 260, a pressure measuring part 270, an anode gas pump 280, a gas-liquid separator 290, a vent and drain valve 295, and a vent and drain pipe 240. In this embodiment, hydrogen is used as an example of anode gas. The anode gas tank 210 stores hydrogen gas at high pressure, for example. The anode gas tank 210 is connected to the fuel cell 600 through the anode gas supply pipe 220. The anode gas supply pipe 220 is provided with the main stop valve 250, the pressure-adjusting valve 260, and the pressure measuring part 270 arranged in this order viewed from the anode gas tank 210. The main stop valve 250 is used for supplying or stopping supply of the anode gas from the anode gas tank 210. The pressure-adjusting valve 260 is used for adjusting the pressure of the anode gas to be supplied to the fuel cell 600. The pressure measuring part 270 measures pressure in the anode gas supply pipe 220. In this embodiment, a value detected by the pressure measuring part 270 is used as anode-side total pressure.

The anode gas reflux pipe 230 is connected to the fuel cell 600 and the anode gas supply pipe 220 and used for causing anode discharge gas discharged from the fuel cell 600 to flow back into the anode gas supply pipe 220. The anode gas reflux pipe 230 is provided with the gas-liquid separator 290 and the anode gas pump 280. Anode discharge gas discharged from the fuel cell 600 contains liquid water, and the gas-liquid separator 290 separates this liquid water from the anode discharge gas. Impurity gas in the anode discharge gas such as nitrogen gas is also separated together with the liquid water. Resultant anode discharge gas containing unused hydrogen gas is driven by the anode gas pump 280 and caused to flow back into the anode gas supply pipe 220. The separated liquid water and nitrogen gas are passed through the vent and drain valve 295 and the vent and drain pipe 240 connected to the gas-liquid separator 290 and released to the outside of the system.

The cathode gas supply unit 100 includes a cathode gas supply pipe 101, a bypass pipe 103, a cathode gas discharge pipe 104, an air cleaner 110, an intercooler 120, a flow dividing valve 130, a pressure-adjusting valve 140, a silencer 150, and an air compressor 160. The cathode gas supply unit 100 takes in air (cathode gas) into the system using the air compressor 160, supplies the air taken in to the fuel cell 600, and then discharges unused air (cathode discharge gas) out of the system.

The cathode gas supply pipe 101 is used for taking in air from outside and supplying the air taken in as cathode gas to the fuel cell 600. The cathode gas supply pipe 101 is provided with the air cleaner 110, an atmospheric pressure sensor 350, an outside air temperature sensor 360, an air flow meter 370, the air compressor 160, the intercooler 120, the flow dividing valve 130, a supplied gas temperature sensor 380, and a supplied gas pressure sensor 390. The air cleaner 110 takes in cathode gas from upstream, removes dust from the cathode gas, and feeds the resultant cathode gas toward downstream. The atmospheric pressure sensor 350 measures atmospheric pressure. The outside air temperature sensor 360 measures the temperature of the cathode gas before being taken in. The air flow meter 370 measures the amount of the cathode gas taken from outside into the cathode gas supply pipe 101. The air compressor 160 compresses the cathode gas supplied from upstream and feeds the compressed cathode gas toward downstream. The intercooler 120 cools the cathode gas compressed and increased in temperature by the air compressor 160. The cooled cathode gas is supplied to the fuel cell 600. The supplied gas temperature sensor 380 measures the temperature of the cathode gas to be supplied to the fuel cell 600. The supplied gas pressure sensor 390 measures the pressure of the cathode gas to be supplied to the fuel cell 600. The flow dividing valve 130 is connected to the bypass pipe 103 and causes the cathode gas to flow in a distributed manner into the fuel cell 600 and the bypass pipe 103.

The cathode gas discharge pipe 104 receives cathode discharge gas from the fuel cell 600 and discharges the received gas to the outside. The cathode gas discharge pipe 104 is provided with the pressure-adjusting valve 140. A downstream section of the bypass pipe 103 is connected to the cathode gas discharge pipe 104 downstream from the pressure-adjusting valve 140. The pressure-adjusting valve 140 adjusts the pressure of the cathode gas in the fuel cell 600. A downstream section of the vent and drain pipe 240 in the anode gas supply unit 200 is connected to a downstream section of the cathode gas discharge pipe 104. The silencer 150 is provided near an exit of the cathode gas discharge pipe 104. The silencer 150 reduces exhaust noise of the cathode discharge gas.

The load connection 800 is a device usable in switching connection between the fuel cell 600 and an electrical load 2000 outside the fuel cell system 700. The load connection 800 connects the fuel cell 600 and the electrical load 2000 during power generation. The electrical load 2000 includes a secondary cell and a power consuming device (such as a motor), for example.

The controller 400 is configured as a logic circuit mainly including a microcomputer. More specifically, the controller 400 includes a CPU that performs predetermined calculations, etc. by following control programs set in advance, a ROM containing control programs, control data, etc. stored in advance necessary for implementation of various types of calculation process by the CPU, a RAM into which and from which various types of data also necessary for implementation of various types of calculation process by the CPU are temporally read and written, and an input and output port for input and output of various signals, for example. The controller 400 acquires signals measured by the pressure measuring part 270 and the potential measuring part 300 and information about load requirement on the fuel cell 600, for example. The controller 400 outputs driving signals to relevant units in the fuel cell system 700 involved in power generation by the fuel cell 600 including valves such as the main stop valve 250, the pressure-adjusting valve 260, the vent and drain valve 295, the flow dividing valve 130, and the pressure-adjusting valve 140, the air compressor 160, and the anode gas pump 280. The controller 400 performs hydrogen supply process (described later) for reducing the occurrence of an abnormal potential in the fuel cell 600.

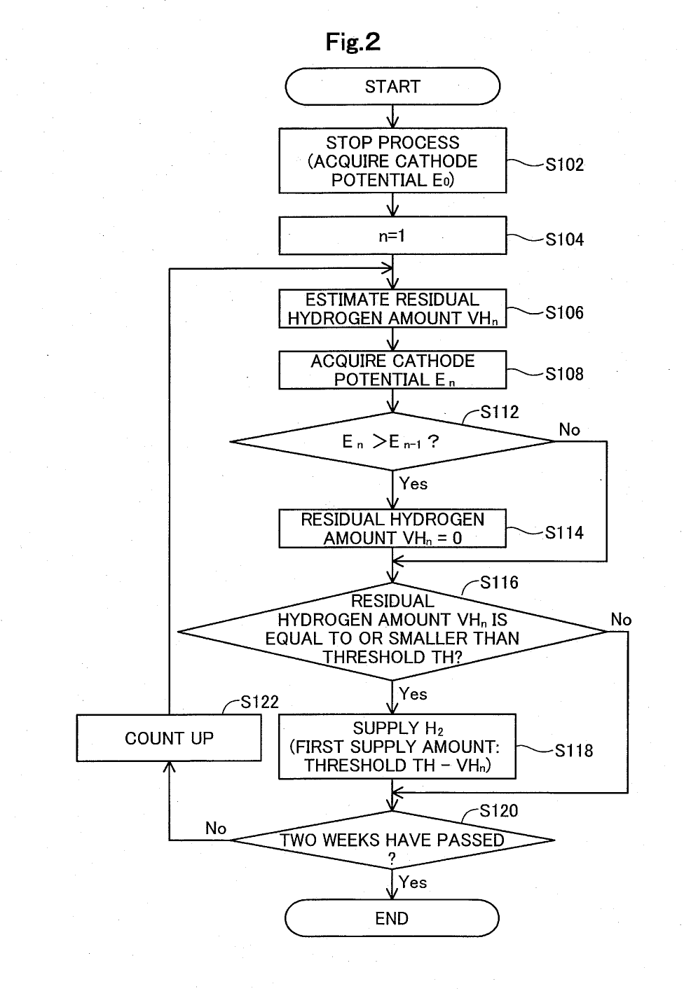

FIG. 2 is a flowchart showing a flow of the hydrogen supply process. Steps from S104 to S122 shown in FIG. 2 are called “hydrogen supply process.” Specifically, FIG. 2 illustrates the hydrogen supply process and stop process together performed before the hydrogen supply process. In this embodiment, the fuel cell system 700 includes a power switch (not shown in the drawings) as an operation element to be used by a user to instruct start and stop of the fuel cell system 700. The fuel cell system 700 is configured in such a manner that, if the user presses the power switch while the fuel cell system 700 is working, the fuel cell system 700 stops. If the power switch is pressed while the fuel cell system 700 is working, the controller 400 performs the process shown in FIG. 2.

In step S102, the controller 400 (see FIG. 1) performs the stop process.

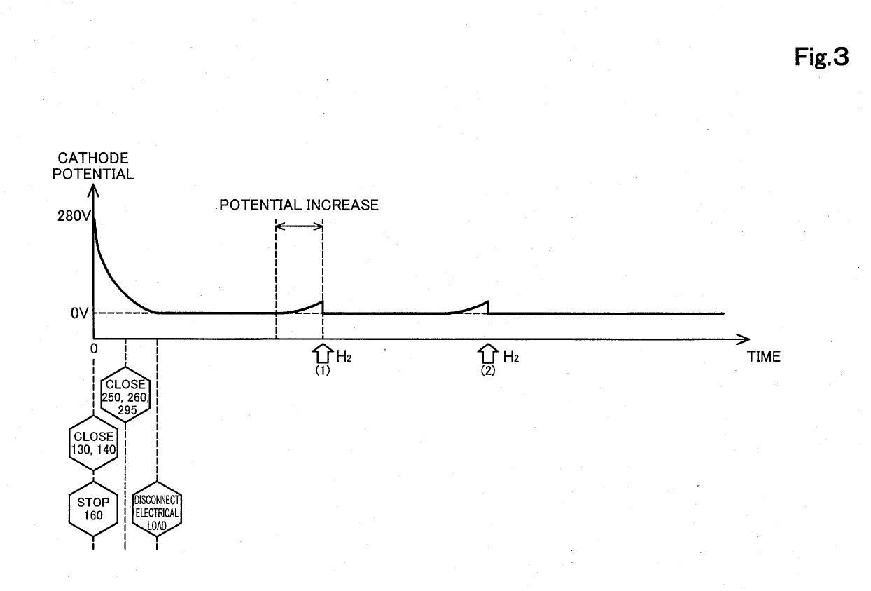

FIG. 3 is an explanatory view conceptually showing change in a cathode potential with time. In the stop process of this embodiment, the controller 400 stops the air compressor 160 (see FIG. 1) to stop supply of cathode gas (see FIG. 3). Further, the controller 400 connects the cathode gas supply pipe 101 and the bypass pipe 103 using the flow dividing valve 130 and closes the pressure-adjusting valve 140 (see FIG. 1), thereby sealing a cathode flow path in the fuel cell 600 (see FIG. 3). Then, the controller 400 supplies hydrogen of a second supply amount from the anode gas tank 210 and thereafter, the controller 400 closes the main stop valve 250, the pressure-adjusting valve 260, and the vent and drain valve 295 (see FIG. 1), thereby sealing an anode flow path (see FIG. 3). In this embodiment, the second supply amount is set to be the same as a threshold TH described later. Next, the controller 400 controls the load connection 800 to disconnect the electrical load 2000 (see FIG. 1) from the fuel cell 600 (see FIG. 3). In the stop process, the controller 400 further acquires a cathode potential E₀ at the time of disconnection of the electrical load 2000. A cathode potential is a total of output voltages from all the potential measuring parts 300. In the description given below, a moment when the electrical load 2000 is disconnected from the fuel cell 600 is also called a “stop process completion moment.”

As shown in FIG. 3, while the controller 400 performs the stop process (see step S102 in FIG. 2), a cathode potential decreases gradually and becomes 0 V when the electrical load 2000 is disconnected. As described above, when the stop process is started, supply of the cathode gas is stopped and the cathode flow path is sealed. Meanwhile, the anode flow path is sealed after hydrogen of the second supply amount is supplied. Thus, the fuel cell 600 generates power using oxygen in the sealed cathode gas flow path and the supplied hydrogen, etc. As a result, oxygen remaining in the cathode side of the fuel cell 600 is consumed.

In step S104 (see FIG. 2), the controller 400 sets n to 1. In step S106, the controller 400 estimates a residual hydrogen amount VHₙ in the anode side of the fuel cell 600. The residual hydrogen amount VHₙ of this embodiment is also called a “residual hydrogen estimated amount.” The residual hydrogen amount VHₙ is calculated by a method described later. The controller 400 starts the hydrogen supply process after passing of time T from completion of the foregoing stop process (step S102). Alternatively, if process in step S106 is to be performed after implementation of process in step S118 described later, the hydrogen supply process is started after passing of the time T from the process in step S106 performed last time. The time T may be set to 24 hours, for example.

In step S108, the controller 400 acquires a cathode potential Eₙ. If the cathode potential Eₙ is higher than a cathode potential Eₙ₋₁ (if Yes in step S112), the controller 400 makes correction to set the residual hydrogen amount VHₙ to zero (step S114). If the cathode potential Eₙ is equal to or lower than the cathode potential Eₙ₋₁ (if No in step S112), the controller 400 does not make the correction in step S114. In this embodiment, “the cathode potential Eₙ being higher than the cathode potential Eₙ₋₁” is also called a “correction condition.” Specifically, if the cathode potential Eₙ acquired in the hydrogen supply process performed for an n-th time satisfies the correction condition, the controller 400 makes the correction to reduce the residual hydrogen amount VHₙ to zero before hydrogen is supplied in the n-th hydrogen supply process.

In step S116, if the residual hydrogen amount VHₙ is equal to or smaller than the threshold TH (if Yes in step S116), the controller 400 controls the main stop valve 250 and the pressure-adjusting valve 260 (see FIG. 1) to supply hydrogen of a first supply amount (step S118). In this embodiment, a difference between the threshold TH and the residual hydrogen amount VHₙ is employed as the first supply amount. If the residual hydrogen amount VHₙ is larger than the threshold TH (if No in step S116), the controller 400 does not make the anode gas supply unit 200 supply hydrogen.

In this embodiment, the amount of hydrogen required to remain in the fuel cell 600 is determined empirically in advance as an amount for avoiding the occurrence of an abnormal potential for three days after the fuel cell 600 stops power generation, and the determined amount is set as the threshold TH. More specifically, a long-term standing test was conducted using the fuel cell 600 in which hydrogen was not supplied in the stop process (specifically, supply of the cathode gas was stopped and supply of hydrogen was stopped simultaneously). Immediately after the stop process was completed, hydrogen of a predetermined supply amount was supplied and then the fuel cell 600 was left unattended. The long-term standing test was conducted while changing the supply amount and a smallest supply amount among those not causing an abnormal potential for three days was employed as the threshold TH. In this embodiment, based on an assumption that the fuel cell system 700 is started by following a starting pattern by which the fuel cell system 700 is stopped on Friday night, not started on Saturday and Sunday, and started on Monday morning. The supply amount of hydrogen is determined so as not to cause an abnormal potential for three days.

The “abnormal potential” is an electrode potential caused by increase of a cathode potential from a normal power generation situation to such a high level as to cause development of cathode degradation (specifically, carbon corrosion). One reason for causing the abnormal potential is considered to be local deficiency of hydrogen in the anode of a fuel cell.

If the controller 400 makes the correction to set the residual hydrogen amount VHₙ to zero in step S114, the residual hydrogen amount VHₙ becomes equal to or smaller than the threshold TH. Thus, in step S118, the controller 400 makes the anode gas supply unit 200 supply hydrogen. The first supply amount corresponds to a difference between the threshold TH and the residual hydrogen amount VHₙ. Thus, if the correction is made to set the residual hydrogen amount VHₙ to zero, the first supply amount becomes equal to the threshold TH and hydrogen of an equal amount to the threshold TH is supplied.

If two weeks have passed since press of the foregoing power switch (if Yes in step S120), the controller 400 finishes the hydrogen supply process. If two weeks have not passed since press of the foregoing power switch (if No in step S120), the controller 400 counts up n and returns to the process in step S106. Specifically, until two weeks have passed since press of the power switch, the controller 400 repeats steps S106 to S122 (corresponding to the hydrogen supply process). In this embodiment, the hydrogen supply process is performed repeatedly at intervals of the time T, specifically, at intervals of 24 hours.

In the hydrogen supply process performed for the first time (specifically, n is one), if a cathode potential E₁ acquired in step S108 is higher than the cathode potential E₀ acquired in the stop process (step S102), the residual hydrogen amount VHₙ is corrected. In the hydrogen supply process performed for the second time or subsequent time (specifically, n is two or more), if the cathode potential Eₙ acquired in step S108 is higher than the cathode potential Eₙ₋₁ acquired in the hydrogen supply process performed last time (specifically, the hydrogen supply process performed for an (n−1)-th time), the residual hydrogen amount VHₙ is corrected.

If instruction to start the fuel cell system 700 is input, the controller 400 finishes the hydrogen supply process (see S104 to S122 in FIG. 2). For example, if the fuel cell system 700 is installed on a vehicle, a user presses the power switch while pressing a brake pedal to input instruction to start the fuel cell system 700. Specifically, even before passing of two weeks, the controller 400 finishes the hydrogen supply system (see S104 to S122 in FIG. 2) in response to input of instruction to start the fuel cell system 700. Thus, if instruction to start is input to the fuel cell system 700 when one day has passed and before two days have passed since completion of the stop process, the hydrogen supply system is performed only once and then finished. If instruction to start is input to the fuel cell system 700 before one day has passed since completion of the stop process, the hydrogen supply process is not performed.

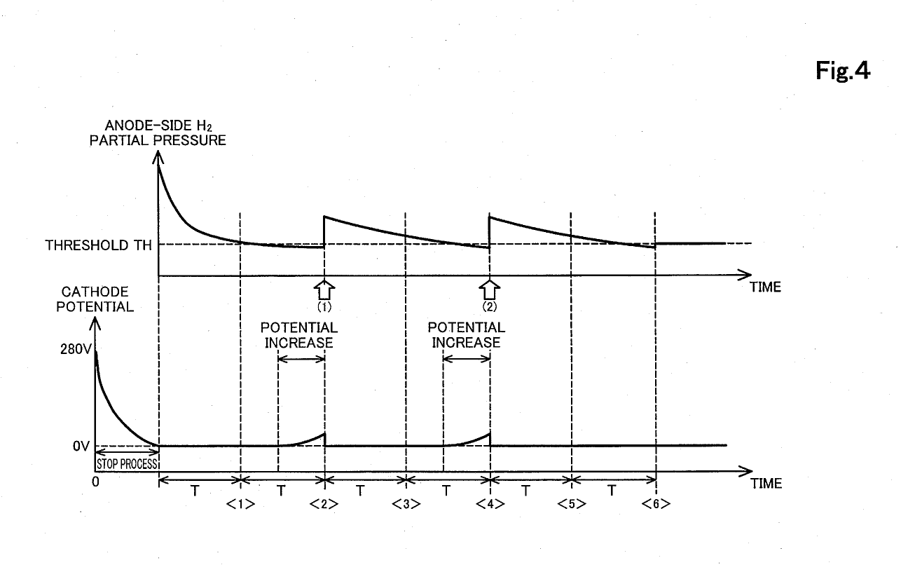

FIG. 4 is an explanatory view conceptually showing change in anode-side hydrogen partial pressure and change in a cathode potential with time. Consumption of oxygen in the anode side in the fuel cell system 700 resulting from implementation of the hydrogen supply process of this embodiment will be described by referring to FIG. 4. FIG. 4 shows change in a cathode potential with time in a lower part and shows anode-side hydrogen partial pressure in an upper part of FIG. 4 in association with a temporal axis in the lower part. In FIG. 4, <n> in the temporal axis in the lower part shows timing of performing the hydrogen supply process for the n-th time (n is a natural number of one or more). The anode side includes a downstream section of the anode gas supply pipe 220 (see FIG. 1) downstream from the pressure-adjusting valve 260, the anode gas flow path in the fuel cell 600, the anode gas reflux pipe 230, and an upstream section of the vent and drain pipe 240 upstream from the vent and drain valve 295. In FIG. 1, the anode side is hatched by diagonals. The cathode side includes a downstream section of the cathode gas supply pipe 101 downstream from the flow dividing valve 130, the cathode gas flow path in the fuel cell 600, and an upstream section of the cathode gas discharge pipe 104 upstream from the pressure-adjusting valve 140.

In the example shown in FIG. 4, at the time of completion of the stop process, oxygen remains in the cathode side and hydrogen remains in the anode side. After completion of the stop process, as a result of disconnection of the electrical load 2000, hydrogen and oxygen move through an electrolyte membrane in the fuel cell 600 (what is called crossover) to consume oxygen. Possible factors for reducing hydrogen in the anode side are reaction with oxygen having entered the fuel cell 600 from outside in addition to reaction with oxygen remaining in the cathode side. Hydrogen in the anode side is used for consuming oxygen, so that the anode-side hydrogen partial pressure is reduced, as shown in the upper part in FIG. 4. After the time T has passed since completion of the stop process, the hydrogen supply process is performed for the first time (see <1> in a lower left region in FIG. 4). In the example shown in FIG. 4, in the first hydrogen supply process, the residual hydrogen amount VH₁ is determined to be larger than the threshold TH (step S116 in FIG. 2: No). Thus, hydrogen is not supplied. When hydrogen in the anode side is used further for consuming oxygen to cause deficiency in hydrogen in the anode side, the cathode potential starts to increase (see the lower part in FIG. 4). In the hydrogen supply process performed for the second time indicated by <2> in a lower left region in FIG. 4, a cathode potential E₂ is determined to be higher than the cathode potential E₁ (Yes in S112 in FIG. 2). Thus, the correction is made to set a residual hydrogen amount VH₂ to zero (see S114 in FIG. 2) and hydrogen of the same amount as the threshold TH is supplied (see (1) in the upper part in FIG. 4). The hydrogen supply process is performed repeatedly in the same way until the user inputs instruction to stop the fuel cell system 700 or until two weeks have passed since press of the power switch. In the hydrogen supply process performed for the fifth time indicated by <5> in a lower right region in FIG. 4, for example, a cathode potential E₅ is equal to a cathode potential E₄ so a residual hydrogen amount VH₅ is not corrected. Further, the residual hydrogen amount VH₅ is determined to be larger than the threshold TH (No in step S116 in FIG. 2). Thus, hydrogen is not supplied. In the hydrogen supply process performed for the sixth time indicated by <6> in a lower right region in FIG. 4, cathode potential E₆ is determined to be equal to the cathode potential E₅ (No in step S112 in FIG. 2, see the lower part in FIG. 4). Thus, a residual hydrogen amount VH₆ is not corrected. Further, the residual hydrogen amount VH₆ is determined to be smaller than the threshold TH (Yes in step S116 in FIG. 2, see the upper part in FIG. 4). Thus, hydrogen of the first supply amount (threshold TH−residual hydrogen amount VH₆) is supplied (see S118 in FIG. 2).

In this embodiment, the controller 400 calculates the residual hydrogen amount VHₙ using the following formulas (1) and (2) (see S106 in FIG. 2). The formula (1) is used for estimating the residual hydrogen amount VHₙ in the hydrogen supply process performed for the first time. The formula (2) is used for estimating the residual hydrogen amount VHₙ in the hydrogen supply process performed for the second time or subsequent time.

(1) First hydrogen supply process (n is one):

VHₙ=((P(n)−Pp)/P(n))×V (1)

Here, P(n) is n-th anode total pressure acquired in the hydrogen supply process performed for the n-th time, Pp is the partial pressure of gas other than hydrogen in the anode side relative to first anode total pressure P(1), and V is the volume of the anode side.

The first residual hydrogen amount VH₁ is estimated using a ratio between anode total pressure and hydrogen partial pressure. In the formula (1), hydrogen partial pressure is calculated using the partial pressure Pp of the gas other than hydrogen existing in the anode side. The gas other than hydrogen existing in the anode side includes nitrogen, water vapor, oxygen, etc. The reason for this is that nitrogen and oxygen in the cathode side move toward the anode side by passing through the electrolyte membrane.

(i) As described above, the volume V of the anode side is a fixed value determined by adding the respective volumes of the downstream section of the anode gas supply pipe 220 (see FIG. 1) downstream from the pressure-adjusting valve 260, the anode gas flow path in the fuel cell 600, the anode gas reflux pipe 230, and the upstream section of the vent and drain pipe 240 upstream from the vent and drain valve 295.

(ii) The first anode total pressure is a value measured by the pressure measuring part 270 (see FIG. 1) acquired in the first hydrogen supply process.

(iii) The partial pressure Pp of the gas other than hydrogen is a value determined uniquely relative to the first anode total pressure. More specifically, during the foregoing long-term standing test, a relationship between the anode total pressure and the partial pressure of the gas other than hydrogen is examined, and a result thereof is stored as anode-side pressure information into the controller 400. The controller 400 derives the partial pressure Pp of the gas other than hydrogen relative to the first anode total pressure using the anode-side pressure information. The partial pressure Pp of the gas other than hydrogen may be calculated based on the volume ratio of gas in the anode gas supply pipe 220 analyzed using a gas analyzer. The partial pressure Pp of the gas other than hydrogen is used for reason that the partial pressure Pp is easier to use than hydrogen partial pressure.

(2) Hydrogen supply process performed for the second time or subsequent time (n is two or more):

VHₙ=VHₙ₋₁−(ΔP/Pav)×V (2)

Here, ΔP is a difference between an n-th anode total pressure value P(n) and an (n−1)-th anode total pressure value P(n−1), and Pav is an average of the n-th anode total pressure value P(n) and the (n−1)-th anode total pressure value P(n−1).

If n is two or more, the residual hydrogen amount VHₙ is determined by subtracting the amount of consumed hydrogen from the residual hydrogen amount VHₙ₋₁ acquired last time. The amount of the consumed hydrogen is calculated using the ratio of the difference ΔP between the n-th anode total pressure value P(n) and the (n−1)-th anode total pressure value P(n−1) to the average Pav of the n-th anode total pressure value P(n) and the (n−1)-th anode total pressure value P(n−1).

The residual hydrogen amount VHₙ in this embodiment is also called an “n-th hydrogen estimated value VHₙ.”

As described above, in the fuel cell system 700 of this embodiment, the anode-side residual hydrogen amount VHₙ is estimated. The residual hydrogen amount VHₙ is an estimated value. Thus, in some cases, the calculated residual hydrogen amount VHₙ is larger than an actual residual hydrogen amount. Unless process such as the correction process of this embodiment is performed if the calculated residual hydrogen amount VHₙ is larger than the actual residual hydrogen amount, hydrogen supply may be omitted in the hydrogen supply process. Even if hydrogen is supplied, the supplied amount may be insufficient. In this embodiment, if a cathode potential acquired in the current hydrogen supply process is increased from a cathode potential acquired in the hydrogen supply process performed last time, the correction is made in the hydrogen supply process to set the residual hydrogen amount VHₙ to zero (see S114 in FIG. 2). In this way, if increase in a cathode potential is detected, hydrogen of the same amount as the threshold TH is supplied (see S118 in FIG. 2). The increase in a cathode potential is highly likely to be caused by deficiency of hydrogen in the anode side. Thus, supplying hydrogen resolves the increase in a cathode potential. This makes it possible to avoid the occurrence of an abnormal potential at the cathode to suppress degradation of the cathode.

In the fuel cell system 700 of this embodiment, if the residual hydrogen amount VHₙ becomes smaller than the threshold TH, hydrogen of the first supply amount is supplied (see S118 in FIG. 2). The first supply amount is determined as a difference between the threshold TH and the residual hydrogen amount VHₙ. The threshold TH is determined as the amount of hydrogen necessary for avoiding the occurrence of an abnormal potential for three days. Thus, hydrogen necessary for avoiding the occurrence of an abnormal potential for three days is supplied to coincide with appropriate timing. In a case of a fuel cell system where hydrogen of an amount necessary for avoiding the occurrence of an abnormal potential for two weeks is supplied in advance in the stop process, and supply of hydrogen is not intended thereafter, the following process may be performed, for example. If the fuel cell system is started three days considerably shorter than two weeks after stop of the fuel cell system, hydrogen of a large amount remains in the anode side and the residual hydrogen is discharged. In comparison to this fuel cell system, the fuel cell system of this embodiment prevents excessive supply of hydrogen, thereby contributing to increase in fuel efficiency.

In this embodiment, hydrogen of the second supply amount is supplied in the stop process. This makes it possible to defer the occurrence of an abnormal potential after stop of the fuel cell system 700, compared to a case where hydrogen is not supplied in the stop process. Additionally, the second supply amount does not exceed the threshold. This allows suppression of fuel efficiency reduction due to excessive supply of hydrogen while consuming oxygen.

### B. Other Embodiments

(1) In the example described in the foregoing embodiment, hydrogen of the second supply amount is supplied in the stop process (see S102 in FIG. 2). Alternatively, hydrogen supply may be omitted in the stop process. The second supply amount may be a constant amount. Further, the second supply amount is not limited to the value described as an example in the foregoing embodiment to be the same as the threshold TH. The second supply amount is appropriately settable in response to timing of performing the hydrogen supply process for the first time or an anode total pressure at the time of implementation of the stop process of the fuel cell system 700, for example.

(2) The threshold TH (see S116 in FIG. 2) and the time T (see S106 in FIG. 2) are not limited to those of the foregoing embodiment but are appropriately settable. The threshold TH may be set to the amount of hydrogen required for avoiding the occurrence of an abnormal potential for one day, for example. In this case, the time T is preferably set to a length of time shorter than one day such as 12 hours or six hours, for example.

The time T corresponding to an interval between implementations of the hydrogen supply process (see S104 to S122 in FIG. 2) may be time empirically determined in advance. The time interval T between implementations of the hydrogen supply process (see S106 in FIG. 2) is set to such a length of time as not to affect requirement for durability of the stack (more specifically, not to cause electrode degradation) even if a cathode potential is increased in the time interval T.

For example, an experiment may be conducted using the fuel cell 600 in which hydrogen is not supplied in the stop process (specifically, supply of the cathode gas is stopped and supply of hydrogen is stopped simultaneously). The fuel cell 600 is left unattended for different lengths of time. The time T may be determined based on a maximum length of unattended time among lengths of unattended time when electrode degradation due to increase in a cathode potential has not occurred. Determining the time T in this way makes it possible to reduce the amount of power to be consumed by the controller for performing the hydrogen supply process.

(3) Different lengths of time may be set as time from completion of the stop process in step S102 in FIG. 2 to implementation of the first hydrogen supply process in step S106, and as an interval between multiple implementations of the hydrogen supply process in step S106 after implementation of the process in step S118. If hydrogen is not to be supplied in the stop process, time from completion of the stop process to start of the first hydrogen supply process may be set to be shorter than an interval between multiple implementations of the hydrogen supply process, for example.

(4) A method of estimating the residual hydrogen amount VHₙ is not limited to the exemplary method using the formulas (1) and (2) described in the foregoing embodiment. For example, if n is two or more, the residual hydrogen amount VHₙ may be calculated using an anode-side hydrogen partial pressure, like in a case where n is one. The anode-side hydrogen partial pressure may be determined based on the ratio of hydrogen obtained using a gas analyzer. Further, if n is one, the residual hydrogen amount VHₙ may be calculated by replacing the (n−1)-th hydrogen supply process by the stop process in the formula (2).

In the foregoing embodiment, the correction condition for determining whether to make the correction to reduce a residual hydrogen estimated amount is satisfied if a cathode potential is higher than a cathode potential acquired in the hydrogen supply process performed immediately before, or if a cathode potential is higher than a cathode potential acquired in the stop process (see S108 and S112 in FIG. 2). However, these are not the limited correction conditions for determining whether to make the correction to reduce a residual hydrogen estimated amount. For example, the correction may be made on condition that an acquired cathode potential is higher than a cathode potential acquired a constant length of time before acquisition of the former cathode potential. In this case, the constant length of time is preferably shorter than the cycle time T of the hydrogen supply process.

(5) A method of correcting the residual hydrogen amount VHₙ is not limited to the exemplary method of S114 in FIG. 2 described in the foregoing embodiment. For example, the residual hydrogen amount VHₙ may be reduced more as a difference between a cathode potential in the current hydrogen supply process and a cathode potential in the hydrogen supply process performed last time (see S108 in FIG. 2) becomes larger. The correction may be made by subtracting a constant amount from the residual hydrogen amount VHₙ or by subtracting a constant ratio of the residual hydrogen amount VHₙ from the residual hydrogen amount VHₙ. This still makes it possible to reduce the occurrence of an abnormal potential, compared to a case of not making correction.

(6) In the example described in the foregoing embodiment, a difference between the threshold TH and the residual hydrogen amount VHₙ is employed as the first supply amount (see S118 in FIG. 2). However, the first supply amount is not limited to this difference. For example, the first supply amount may be a constant amount. However, the first supply amount is preferably determined based on a difference between the threshold TH and the residual hydrogen amount VHₙ. For example, a relationship between a difference between the threshold TH and the residual hydrogen amount VHₙ and the first supply amount may be determined in advance, and first supply amount information indicating the relationship may be stored in the controller 400. In this configuration, the controller 400 may determine the first supply amount using the first supply amount information. In this case, the first supply amount may be determined by adding a constant amount to a difference between the threshold TH and the residual hydrogen amount VHₙ. Alternatively, the first supply amount may be a value obtained by multiplying a difference between the threshold TH and the residual hydrogen amount VHₙ by a coefficient.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to one aspect of the technique disclosed in this specification, a fuel cell system is provided. The fuel cell system comprises: a fuel cell; an anode gas supply unit that supplies hydrogen as anode gas to the fuel cell; a cathode gas supply unit that supplies cathode gas to the fuel cell; a controller that controls operation of the fuel cell; and a potential measuring part that measures a cathode potential at the fuel cell. In this fuel cell system, after the controller performs stop process of stopping power generation by the fuel cell, the controller performs hydrogen supply process n times (n is a natural number of one or more) if a residual hydrogen estimated amount showing an estimated amount of the hydrogen remaining in an anode side of the fuel cell is smaller than a threshold. The hydrogen supply process is to make the anode gas supply unit supply the hydrogen of a first supply amount responsive to a difference between the threshold and the residual hydrogen estimated amount. If the cathode potential acquired in the hydrogen supply process performed for an n-th time satisfies a correction condition, the controller corrects the residual hydrogen estimated amount by reducing the residual hydrogen estimated amount before supply of the hydrogen in the n-th hydrogen supply process. If n is one, the correction condition is satisfied if the cathode potential acquired in the n-th hydrogen supply process is higher than the cathode potential acquired in the stop process. If n is two or more, the correction condition is satisfied if the cathode potential acquired in the n-th hydrogen supply process is higher than the cathode potential acquired in the hydrogen supply process performed for an (n−1)-th time.

In the fuel cell system of this aspect, if the cathode potential acquired in the hydrogen supply process satisfies the correction condition, correction is made to reduce the residual hydrogen estimated amount before supply of hydrogen. If hydrogen is supplied in the hydrogen supply process, the supplied hydrogen is of the first supply amount responsive to a difference between the threshold and the residual hydrogen estimated amount. Thus, by making the correction to reduce the residual hydrogen estimated amount, the amount of the supplied hydrogen becomes larger than a supply amount determined by using the residual hydrogen estimated amount before the correction. If the cathode potential acquired in the hydrogen supply process satisfies the correction condition, an abnormal potential may occur. Specifically, hydrogen remaining in the fuel cell may be insufficient. By making the foregoing condition, more hydrogen is supplied than in a case of not making the correction, thereby resolving deficiency of hydrogen. As a result, the occurrence of an abnormal potential is reduced. Further, oxygen remaining in the fuel cell is consumed to suppress electrode degradation. Specifically, in the fuel cell system of this aspect, hydrogen of an amount appropriate for reducing the occurrence of an abnormal potential is supplied.

(2) In the fuel cell system of the foregoing aspect, in the stop process, after the controller stops supply of the cathode gas, the controller may supply hydrogen of a second supply amount not exceeding the threshold and then stop supply of hydrogen. This makes it possible to reduce the occurrence of an abnormal potential further due to deficiency of hydrogen in the fuel cell, compared to a case of not supplying hydrogen in the stop process. Further, the second supply amount does not exceed the threshold. This allows suppression of fuel efficiency reduction due to excessive supply of hydrogen while consuming oxygen.

(3) The fuel cell of the foregoing aspect may further comprise a pressure measuring part that measures anode total pressure that is total pressure in anode side of the fuel cell. The controller may contain anode-side pressure information indicating a relationship between the anode total pressure determined empirically in advance and the partial pressure of gas other than hydrogen existing in the anode side. The controller may calculate the residual hydrogen estimated amount using the anode total pressure acquired in the hydrogen supply process and the anode-side pressure information. This facilitates calculation of the residual hydrogen estimated amount.

(4) In the fuel cell system of the foregoing aspect, the residual hydrogen estimated amount estimated in the hydrogen supply process performed for the n-th time is designated as an n-th residual hydrogen estimated amount VHₙ, and the n-th residual hydrogen estimated amount VHₙ is calculated using a formula (1) if n is one and using formula (2) if n is two or more:

VHₙ=HP(n)−Pp)/P(n))×V (1)

VHₙ=VHₙ₋₁−(ΔP/Pav)×V (2).

Here, P(n) is n-th anode total pressure acquired in the hydrogen supply process performed for the n-th time, Pp is the partial pressure of gas other than hydrogen relative to first anode total pressure P(l) in the anode-side pressure information, V is the volume of the anode side, LP is a difference between an n-th anode total pressure value P(n) and an (n−1)-th anode total pressure value P(n−1), and Pav is an average of the n-th anode total pressure value P(n) and the (n−1)-th anode total pressure value P(n−1).

The foregoing achieves estimation of the residual hydrogen estimated amount more correctly.

(5) According to another aspect of the technique disclosed in this specification, a fuel cell system is provided. The fuel cell system comprises: a fuel cell; an anode gas supply unit that supplies hydrogen as anode gas to the fuel cell; a cathode gas supply unit that supplies cathode gas to the fuel cell; a controller that controls operation of the fuel cell; and a potential measuring part that measures a cathode potential at the fuel cell. In this fuel cell system, after the controller performs stop process of stopping power generation by the fuel cell, the controller repeatedly performs hydrogen supply process. The hydrogen supply process comprises: determining a residual hydrogen estimated amount showing an estimated amount of hydrogen remaining in an anode side of the fuel cell; making correction to reduce the residual hydrogen estimated amount if a correction condition indicating increase in the cathode potential is satisfied; and making the anode gas supply unit supply hydrogen of an amount not exceeding a predetermined amount if the residual hydrogen estimated amount is smaller than a threshold.

(6) In the fuel cell system of the foregoing aspect, the amount of hydrogen to be supplied if the residual hydrogen estimated amount is smaller than the threshold is determined based on a difference between the threshold and the residual hydrogen estimated amount.

(7) In the fuel cell system of the foregoing aspect, regarding the residual hydrogen estimated amount determined, for the first time after implementation of the stop process, the correction condition is satisfied if the cathode potential is higher than a cathode potential acquired in the stop process, and regarding the residual hydrogen estimated amount determined for the second time or subsequent time after implementation of the stop process, the correction condition is satisfied if the cathode potential is higher than a cathode potential acquired in the hydrogen supply process performed last time.

(8) In the fuel cell system of the foregoing aspect, in the stop process, after the controller stops supply of the cathode gas, the controller supplies hydrogen of a second supply amount not exceeding the threshold and then stops supply of hydrogen.

(9) In the fuel cell system of the foregoing aspect further comprises: a pressure measuring part that measures anode total pressure that is total pressure in anode-side of the fuel cell. The controller contains anode-side pressure information indicating a relationship between the anode total pressure determined empirically in advance and the partial pressure of gas other than hydrogen existing in the anode side. The controller calculates the residual hydrogen estimated amount using the anode total pressure acquired in the hydrogen supply process and the anode-side pressure information.

(10) In the fuel cell system of the foregoing aspect, an n-th residual hydrogen estimated amount VHₙ is calculated using a formula (1) if n is one, and using a formula (2) if n is two or more, the n-th residual hydrogen estimated amount VHₙ being the residual hydrogen estimated amount estimated in the hydrogen supply process performed for an n-th time (n is an integer of one or more):

VHₙ=((P(n)−Pp)/P(n))×V (1)

VHₙ=VHₙ₋₁−(ΔP/Pav)×V (2),

where P(n) is n-th anode total pressure acquired in the hydrogen supply process performed for the n-th time, Pp is the partial pressure of gas other than hydrogen relative to first anode total pressure P(1) in the anode-side pressure information, V is the volume of the anode side, ΔP is a difference between an n-th anode total pressure value P(n) and an (n−1)-th anode total pressure value P(n−1), and Pav is an average of the n-th anode total pressure value P(n) and the (n−1)-th anode total pressure value P(n−1).

The technique disclosed in this specification is feasible in various aspects. For example, this technique is feasible as, a movable body with a fuel cell system, a method of controlling the fuel cell system, etc.

What is claimed is:

1. A fuel cell system comprising:
a fuel cell;
an anode gas supply unit that supplies hydrogen as anode gas to the fuel cell;
a cathode gas supply unit that supplies cathode gas to the fuel cell;
a controller that controls operation of the fuel cell; and
a potential measuring part that measures a cathode potential at the fuel cell, wherein
after the controller performs stop process of stopping power generation by the fuel cell, the controller repeatedly performs hydrogen supply process comprising:
determining a residual hydrogen estimated amount showing an estimated amount of hydrogen remaining in an anode side of the fuel cell;
making correction to reduce the residual hydrogen estimated amount if a correction condition indicating increase in the cathode potential is satisfied; and
making the anode gas supply unit supply hydrogen of an amount not exceeding a predetermined amount if the residual hydrogen estimated amount is smaller than a threshold.

2. The fuel cell system in accordance with claim 1, wherein
the amount of hydrogen to be supplied if the residual hydrogen estimated amount is smaller than the threshold is determined based on a difference between the threshold and the residual hydrogen estimated amount.

3. The fuel cell system in accordance with claim 1, wherein
regarding the residual hydrogen estimated amount determined for the first time after implementation of the stop process, the correction condition is satisfied if the cathode potential is higher than a cathode potential acquired in the stop process, and
regarding the residual hydrogen estimated amount determined for the second time or subsequent time after implementation of the stop process, the correction condition is satisfied if the cathode potential is higher than a cathode potential acquired in the hydrogen supply process performed last time.

4. The fuel cell system in accordance with claim 1, wherein
in the stop process, after the controller stops supply of the cathode gas, the controller supplies hydrogen of a second supply amount not exceeding the threshold and then stops supply of hydrogen.

5. The fuel cell system in accordance with claim 1, further comprising:
a pressure measuring part that measures anode total pressure that is total pressure in anode-side of the fuel cell, wherein
the controller contains anode-side pressure information indicating a relationship between the anode total pressure determined empirically in advance and the partial pressure of gas other than hydrogen existing in the anode side, and
the controller calculates the residual hydrogen estimated amount using the anode total pressure acquired in the hydrogen supply process and the anode-side pressure information.

6. The fuel cell system in accordance with claim 5, wherein
an n-th residual hydrogen estimated amount VHₙ is calculated using a formula (1) if n is one, and using a formula (2) if n is two or more, the n-th residual hydrogen estimated amount VHₙ being the residual hydrogen estimated amount estimated in the hydrogen supply process performed for an n-th time (n is an integer of one or more):
VHₙ=((P(n)−Pp)/P(n))×V (1)
VHₙ=VHₙ₋₁−(ΔP/Pav)×V (2),
where P(n) is n-th anode total pressure acquired in the hydrogen supply process performed for the n-th time, Pp is the partial pressure of gas other than hydrogen relative to first anode total pressure P(1) in the anode-side pressure information, V is the volume of the anode side, ΔP is a difference between an n-th anode total pressure value P(n) and an (n−1)-th anode total pressure value P(n−1), and Pav is an average of the n-th anode total pressure value P(n) and the (n−1)-th anode total pressure value P(n−1).
